(19) United States
(12) Patent Application Publication
(10) Pub. No.: US 2002/0187220 A1
(43) Pub. Date: Dec. 12, 2002

(54) Edible particulate adhesive

(76) Inventor: Ashok Premchand Luhadiya, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/853,390

(22) Filed: May 11, 2001

(51) Int. Cl. A23L 1/00

(52) U.S. Cl. 426/89

(57) ABSTRACT

The present invention provides an edible adhesive that is suitable for affixing edible particulates to foods; and adhesive coated foods having an enhanced appearance, and improved nutritional and organoleptic properties.

### FIELD OF THE INVENTION

The present invention relates to edible particulate adhesives and to particulate-coated foods.

### BACKGROUND OF THE INVENTION

In the manufacture of various types of foods, particularly ready-to-bake or ready-to-microwave fried foods and the like, it is conventional to add particulates, such as spices, after the product has already been formed. In the case of food products cooked in fat or oil, this is typically done by dusting the product with the particulate, the residual fat or oil acting as an adhesive that binds the particulate to the product. In other cases, the particulate may be added by applying a fat, or oil coating, containing the particulate, to the already-formed product.

Although particulates such as vitamins and spices can easily be incorporated into mixes used to prepare foods, methods of applying particulates to solid foods, such as French fries and potato chips, are generally limited to surface applications. While solid foods can be surface coated, these foods typically have a limited surface area in comparison to their volume, and particulates may be lost during subsequent stages of processing.

In addition to the challenges associated with applying particulates to solid foods, changes in food formulations have resulted in the need for an edible adhesive having an increased load carrying capacity and cohesiveness, and decreased drying time. For example, as a result of dietary concerns, trigylceride based fats and oils that were used in and on foods have been replaced with partially digestible or non-digestible fats, such as polyol polyesters. While partially digestible or non-digestible fats can be used to reduce the digestible oil and fat levels of foods, partially digestible or non-digestible fats are also known to reduce the absorption of lipophilic micronutrients, such as fat-soluble vitamins. See: The Effect of Nonabsorbable Lipids on the Intestinal Absorption of Lipophiles, by Jandacek, R. J., Drug Met. Rev. 13, 695-714, (1982) and Evaluation of the Potential for Olestra to Affect the Availability of Dietary Phytochemicals, by Cooper, D. A. et al. J. Nutr. 127, 1699S-1709S, (1997). As a result, in addition to seasonings, foods that incorporate partially digestible or non-digestible fats typically require vitamin fortification. Unfortunately, known adhesives cannot carry the significant particulate load of vitamins and spices that is required for these applications, nor can they provide the adhesive properties and rapid drying that is desired.

In addition to having the desired adhesiveness, load carrying, and drying properties, it is desirable that a particulate adhesive impart no extraneous tastes, texture, odors, or undesirable visual effects; only a minimal caloric load; and require no additional processing steps. At present no suitable adhesive has been found.

### SUMMARY OF THE INVENTION

Applicant's invention relates to an edible particulate adhesive comprising:

a.) from about 18% to about 71%, by weight, modified starch;

b.) from about 27% to about 80%, by weight, maltodextrin;

c.) from about 0.01% to about 7%, by weight, of an edible surfactant;

d.) from about 0.02% to about 2.5%, by weight, polysaccharide; and

e.) a solvent;

said edible adhesive having a cohesiveness from about 215 g/s to about 700 g/s and a viscosity of not more than about 800 cps.

### DETAILED DESCRIPTION OF THE INVENTION

### Definitions

As used herein, the terms “edible particulate adhesive” and “edible adhesive” are synonymous.

As used herein, the term “adhesive component mix” refers to a mix of materials that does not include added solvent; but, when combined with added solvent, forms Applicant's edible adhesive.

As used herein, the term “particulate” includes but is not limited to flavorings, seasonings, condiments, colorants, odorants, confections, vitamins, minerals, nutritive supplements, decorative toppings or mixtures thereof.

As used herein, the term “organoleptic properties” includes the flavor display, texture, and sound of a food that are experienced by the eater of said food when said food is eaten.

For purposes of this invention “% by weight” is defined as the weight of a component of Applicant's adhesive, other than added solvent, divided by the sum of the weights of all components of Applicant's adhesive except any added solvent.

All percentages and ratios are calculated by weight unless otherwise indicated.

For purposes of this invention “adhesive weight percent basis” is defined as the weight of a particulate divided by the weight of the finished adhesive to which the particulate will be added.

As used herein the articles a and an when used in a claim, for example, “a particulate” or “an ionic surfactant” is understood to mean at least one of the components that are claimed or described.

Publications, patents, and patent applications are referred to throughout this disclosure. All references cited herein are hereby incorporated by reference.

All component or composition levels are in reference to the active level of that component or composition, and are exclusive of impurities, for example, residual solvents or by-products, which may be present in commercially available sources.

Edible Particulate Adhesive

Applicant's invention is an edible particulate adhesive comprising modified starch, maltodextrin, a surfactant, a polysaccharide, added solvent, and, optionally, one or more particulates. An adhesive component mix, comprising all the components of Applicant's edible adhesive except added solvent, said components being present in the same weight percentages as disclosed for Applicant's edible adhesive, is also provided.

Applicant's adhesive has the advantages of being easy to prepare and easy to apply. The adhesive can be applied without heating or dilution, and it is sprayable at ambient temperatures, including, for example, 23° C. When applied to a food, Applicant's adhesive dries quickly, without the need for further drying processes, to form an essentially invisible, low calorie, odorless and colorless film. An additional advantage of Applicant's adhesive is the adhesive's ability to adhere particulates to oily substrates.

Desirable particulates that can be carried by and adhered to foods by Applicant's adhesive include, but are not limited to, particulates such as herbs, spices, seasonings, seeds, vitamins and minerals. Preferable particulates have a particle size of less than about 650 microns—the edible particulate adhesive can carry at least about 15% w/w of such particulate materials.

Modified Starch

Starches are polymers of glucosyl units and the predominant food reserve found in plants. Commercial starches are obtained from cereal grain seeds; particularly from corn, waxy corn, high amylose corn, wheat, and rice; and from tubers and roots such as potatoes, sweet potatoes, and tapioca.

Modified starches are starches that have been chemically modified to enhance or optimize characteristics including solubility, paste viscosity, clarity, and strength. Applicant's invention comprises a modified starch. For purposes of this invention maltodextrin is not considered a modified starch.

Embodiments of Applicant's edible particulate adhesive comprise from about 18% to about 71% modified starch. Other embodiments of Applicant's edible particulate adhesive comprise from about 18% to about 59% modified starch. Still other embodiments of Applicant's edible particulate adhesive comprise from about 21% to about 50% modified starch. Certain embodiments of Applicant's invention comprise a high amylopectin containing, cold-water soluble, modified starch. Examples of suitable modified starches include, but are not limited to, N-Tack and Purity Gum 59, which are supplied by National Starch and Chemical Company of Bridgewater, N.J. U.S.A.

Maltodextrin

Maltodextrins having dextrose equivalences from about 4 to about 20 may be used in the present invention. Suitable maltodextrins include, but are not limited to, Maltrin 40, Maltrin 100, Maltrin 150 and Maltrin 200, which are supplied by Grain Processing Corporation of Muscatine, Iowa U.S.A.

Embodiments of Applicant's edible particulate adhesive comprise from about 27% to about 80% maltodextrin. Other embodiments of Applicant's edible particulate adhesive comprise from about 27% to about 65% maltodextrin. Still other embodiments of Applicant's edible particulate adhesive comprise from about 36% to about 58% maltodextrin.

Edible Surfactant

Embodiments of Applicant's edible particulate adhesive comprise from about 0.01% to about 7% by weight of a suitable surfactant. Other embodiments of Applicant's edible particulate adhesive comprise from about 0.2% to about 5.3% of a suitable surfactant. Still other embodiments of Applicant's edible particulate adhesive comprise from about 1% to about 4.5% of a suitable surfactant.

The preferred suitable surfactants are nonionic surfactants having a HLB of 4.7 to 18.0. Examples of suitable surfactants include, but are not limited to, sorbitan monostearate, which is marketed under the trade name Span 60; sorbitan tristearate which is marketed under the trade name Span 65; POE(20) sorbitan mono stearate which is marketed under the trade name Tween 60; POE(20) sorbitan tristearate which is marketed under the trade name Tween 65; POE(20) sorbitan monooleate which is marketed under the trade name Tween 80; polyoxyethylene (20) monolaurate which is marketed under the trade name Tween 20; polyoxyethylene (8) stearate which is marketed under the trade name Myrj 45; and polyoxyethylene (40) stearate which is marketed under the trade name Myrj 52; all of which are sold by ICI Surfactants of Wilmington, Del. U.S.A. Additional examples of suitable surfactants include acid esters of monoglycerides, which are marketed under the trade name Panodan by Danisco Ingredients of New Century, Kans. U.S.A., and glycerol esters, which are marketed under the trade names Caprol PGE 860 and Caprol 3 GO by Abitec Corp. of Janesville, Wis. U.S.A.

Polysaccharide

Embodiments of Applicant's edible particulate adhesive comprise from about 0.02% to about 2.5% of a suitable polysaccharide. Other embodiments of Applicant's edible particulate adhesive comprise from about 0.1% to about 2.2% of a suitable polysaccharide. Still other embodiments of Applicant's edible particulate adhesive comprise from about 0.2% to about 1.6% of a suitable polysaccharide.

Suitable polysaccharides include, but are not limited to edible grades of: carboxymethyl cellulose, methyl cellulose, ethyl cellulose, guar gum, locust bean gum, xanthan gum, carrageenans, gellan, konjac flour, sodium alginates, pectin, gum, and mixtures thereof. Examples of suitable polysaccharides include carrageenan which is sold under the trade name Vegi Film by TIC Gums Inc. of Belcamp, Md. U.S.A. and gellan which is sold under the trade name Kelcogel F by Kelco Biopolymers of San Diego, U.S.A.

Solvent

Applicant's edible particulate adhesive comprises, sufficient quantities of one or more edible solvents to result in a cohesiveness, as measured using Applicant's Cohesiveness Test Protocol, of from about 215 g/s to about 700 g/s. Other embodiments of Applicant's adhesive composition comprise sufficient quantities of one or more solvents to result in a cohesiveness, as measured using said Cohesiveness Test Protocol, of from about 300 g/s to about 650 g/s. Still other embodiments of Applicant's edible particulate adhesive comprise sufficient quantities of one or more solvents to result in a cohesiveness, as measured using said Cohesiveness Test Protocol, of from about 350 g/s to about 500 g/s.

In addition to being present in sufficient quantities to provide the desired cohesive properties, said solvent is present in sufficient quantities to result in an adhesive viscosity, as measured using Applicant's Viscosity Test Protocol, of not more than about 800 cps. Other embodiments of Applicant's edible particulate adhesive comprise sufficient quantities of one or more solvents to result in an adhesive viscosity, as measured using said Viscosity Test Protocol, of not more than about 650 cps. Still other embodiments of Applicant's edible particulate adhesive comprise sufficient quantities of one or more solvents to result in an adhesive viscosity, as measured using said Viscosity Test Protocol, of not more than about 550 cps.

Optional Ingredients

Optional ingredients include, but are not limited to, acidulants, sweeteners, preservatives and colorants. Acidulants can be used as antimicrobial agents. Suitable acidulants include citric acid and anhydrous citric acid. Conventional preservatives may be used. Suitable preservatives include, but not are limited to, potassium sorbate, sorbic acid, benzoic acid and propionic acids or their salts, and alkyl esters of p-hydroxy-benzoic acid, also known as parabens. Edible colorants can be added where desired. Where desired, sweeteners including, but not limited to, sorbitol, and other sugars may be added to the edible particulate adhesive.

Preparation Of Edible Particulate Adhesive

When preparing the adhesive of the present invention, the ability of the selected solvent to provide a viscosity and cohesiveness suitable for application and to dissolve the ingredients must be balanced against a food substrate's undesirable tendency to absorb solvent. Applicant's edible particulate adhesive can be prepared by slowly combining a modified starch and a maltodextrin with the proper quantity of one or more solvents while stirring or mixing. Next, a surfactant is combined with the solution while mixing or stirring. After the surfactant is added, the solution is stirred or mixed for about 10 minutes. Then, a polysaccharide is added to the solution and the resulting solution is mixed thoroughly. The resulting solution is then heated to about 80° C. and maintained at about 80° C. until the polysaccharides dissolve. The solution is then cooled to about ambient temperature. Next, a sufficient amount of solvent is added to the solution to compensate for any solvent lost during heating. The amount of added solvent will depend on factors such as the elevation at which the edible particulate adhesive is prepared and the difficulty of dissolving the polysaccharides. Finally, if desired, particulate matter can be added to the solution with stirring or mixing. The solution so formed can then be used to adhere particulate matter to foods.

In an alternative embodiment, Applicant's adhesive mix can be combined with a solvent, whose temperature is at or about 80° C., to produce Applicant's edible adhesive. Preferably the combined mix and solvent are maintained at about 80° C. and mixed or stirred until said mix dissolves in said solvent.

Methods of Application

Applicant's edible particulate adhesive can be applied to foods by methods including, but not limited to, spraying, brushing, dipping or ladling; the particular method used depends upon the food substrate. A particulate can be combined with Applicant's edible particulate adhesive, and then the mixture can be applied to a food, or the edible particulate adhesive can be applied to the food and then a particulate can be applied, by methods including but not limited to dusting, sprinkling or enrobing. Multiple coats of edible particulate adhesive and particulate may be applied if desired. Detailed methods for applying edible adhesives and adhering particulates to foods are disclosed in U.S. Pat. Nos. 5,964,146; 5,798,132; and 3,527,646 which are hereby incorporated by reference. A particular advantage of the edible particulate adhesive is that it is sprayable at ambient temperatures, including, for example, 23° C. Thus, Applicant's edible particulate adhesive can be sprayed onto a food substrate using conventional spray equipment that creates an atomizing air spray, and is approved for use in food preparation, such as an automatic spray gun model 460 from Binks Manufacturing Company, Franklin Park Ill. Preferably, Applicant's edible particulate adhesive is applied to foods having a surface temperature that is greater than 23° C., most preferably Applicant's edible particulate adhesive is applied to foods having a surface temperature that is greater than 93° C.

Generally, after Applicant's edible particulate adhesive is applied, no additional drying step is required to dry the adhesive and thereby adhere the particular matter to the coated food. However, when the food substrate is at ambient temperature prior to applying the edible particulate adhesive, a subsequent drying step is often preferred to achieve desired organoleptic properties, such as crispness. Good results can be obtained by drying the coated food in a conventional oven at about 40° C. for about 1-2 hours.

Particulate And Carrier Coated Foods

The present invention also relates to foods, including, for example, French fries, chips, pretzels, snack mixes, nuts, cereals, crackers and popcorn, that have been coated with Applicant's edible particulate adhesive or with Applicant's edible particulate adhesive and a particulate. When Applicant's adhesive has been employed to adhere particulates to a food, said foods can have lower processing costs, enhanced organoleptic properties, an enhanced appearance, and an improved nutritional profile.

The amount of the edible particulate adhesive applied to a food depends upon the food, the method of application, and the type and amount of particulate being adhered to the food. Typically, the amount of edible particulate adhesive and particulate applied to the food, before evaporation of the solvent, is up to about 5%, preferably up to about 3%, more preferably up to about 1.5%, of the weight of the coated food.

Analytical Test Methods

Cohesiveness Test Protocol

The textural value of an edible adhesive solution is the parameter that is used to define the cohesiveness of the edible adhesive. Textural values are measured using a TA-XT2 Texture Analyzer (Version 05.16 equipped with 25-1 load cell, Texture Technologies Corp., Scarsdale, N.Y.). The Texture Analyzer is linked to a standard personal computer (e.g. IBM 433DX) that records the generated data via a software program called XTRA Dimension (Version 3.7H, Texture Technologies Corp., Scarsdale, N.Y.). The Texture Analyzer is configured with a circular disc, and steel plate probe (50mm diameter, 20mm thickness) that is fastened vertically to the main arm of the Texture Analyzer.

1.) Procedure for Set-up and Calibration of Texture Analyzer

a.) Set-up the Texture Analyzer as follows:

| | | |
|---|---|---|
| (i) | Mode: | Measure Force in Compression |
| (ii) | Option: | Adhesive Test |
| (iii) | Force Units: | Grams |
| (iv) | Time Units: | Seconds |
| (v) | Distance Format: | mm |
| (vi) | Pre-Test Speed: | 2.0 mm/s |
| (vii) | Probe Test Speed: | 1.0 mm/s |
| (viii) | Post-Test Speed: | 1.0 mm/s |
| (ix) | Distance: | 20.0 mm |
| (x) | Force: | 500.0 g |
| (xi) | Time: | 2.0 s |
| (xii) | Trigger Type: | Auto |
| (xiii) | Trigger Force: | 10 g |

b.) Setup the texture method as follows:

| | | |
|---|---|---|
| (i) | Graph Type: | Force vs. Time |
| (ii) | Auto-Scaling | Off |
| (iii) | Force Scaling Max.: | 10,000 g |
| (iv) | Force Scaling Min.: | −1,000 g |
| (v) | Peak Confirmation: | Off |
| (vi) | Force Threshold: | 20 grams |
| (vii) | File Type: | LOTUS 1-2-3 |
| (viii) | Display and Export: | Plotted Points |
| (ix) | Acquisition Rate: | 200 pps |
| (x) | Force Units: | Grams |
| (xi) | Contact Area: | 1.00 mm² |
| (xii) | Contact Force: | 5.0 g |

c.) Calibrate the force scale by placing a 5 kg weight on the calibration platform and press the “calibrate” button on the Texture Analyzer keypad.

d.) Ensure that the probe's starting distance is 30 mm from the base plate and that the bottom surface of the probe is parallel to the surface on the base plate.

2.) Procedure for Sample Measurements

Six (6) samples from the same batch of liquid adhesive are tested in the manner detailed below. The textural analysis for each sample should be completed within 1-2 minutes after Step (b) below.

a.) Equilibrate the liquid adhesive to 25 C for 1 hour prior to beginning the textural analysis.

b.) Uniformly spread 2.0 ml of the adhesive solution on the center of the base plate so that when the probe is in contact with the base plate, the probe is uniformly in contact with the liquid adhesive.

c.) Initiate the compression test.

d.) Save the resulting Force (grams) vs. Time (sec.) plot for later analysis.

3.) Data Analysis

a.) The following is obtained form each sample's “Force vs. Time” plot:

(i) Peak force in grams

(ii) Area (gram/sec.) under the curve up to the peak force

(iii) Area (gram/sec.) under the curve after the peak force

b.) After obtaining the data required by Step 3(a) above, the six values for the area under the curve after the peak force are averaged.

c.) For the purposes of the present invention, the average value for the area under the curve, after the peak force, is designated as the cohesiveness value for the liquid adhesive.

Viscosity Test Protocol

The viscosity of the liquid adhesive solution is measured using a Contrave Rheomat (Version 108, Rheometric Scientific Inc. N.J.) equipped with measuring probe #2. In order to generate an adhesive viscosity value, three (3) samples from the same batch of edible adhesive are tested.

1.) Calibrate the Rheomat using standard viscosity oils ranging from 100 to 600 cps.

2.) Equilibrate the liquid edible adhesive solution at 25° C. for 1 hour prior to beginning the viscosity analysis.

3.) Transfer a 100 ml sample of the liquid edible adhesive solution to the Rheomat cup and immerse the spindle (probe #2) to the mark on the spindle.

4.) Adjust the rotation speed to obtain an actual measurement within the viscosity range of 100-1000 cps.

5.) For purposes of the present invention, the average of the viscosity values for the three samples is the adhesive's viscosity value.

Particle Adhesion Measurement Protocol

1.) Suspend 10% by weight of 350 micron stabilized vitamin particulates (supplied by Wright Nutrition, Inc. of Crowley, La. U.S.A.) in the edible adhesive.

2.) Next, uniformly spray the adhesive at the rate of one percent by weight, on to chips having a temperature of 23° C.

3.) Then, using a microscope, count the number of vitamin particulates per square centimeter of chip and mark the area counted.

4.) Freeze the chips at −40° C. for 20 minutes.

5.) Then place the chips in a coating pan and rotate the chips at 24 rpm for 2 minutes.

6.) At the end of the rotation period, the number of particulates retained on the designated chip area are counted as per #3 above and percent retention is calculated.

### EXAMPLES

The following are specific embodiments of the present invention. These examples are illustrative of the invention and are not to be construed to limit the invention in any way.

### Example 1

An edible particulate adhesive having the following formulation is prepared as follows:

| Ingredient | wt/wt % |
|---|---|
| N-Tack | 10.00 |
| Purity Gum 59 | 5.00 |
| Maltodextrin 150 | 45.00 |
| Tween 80 | 2.10 |
| Vegi Film | 0.35 |
| Water | 37.55 |

1. The water is placed into a container.

2. The N-Tack, Purity Gum 59 and Maltodextrin 150 are slowly added to the water with constant stirring until the solution is aggregate free and essentially clear.

3. Next, the Tween 80 is added to the N-Tack, Maltodextrin 150 and water mixture and the resulting mixture is mixed for 10 minutes.

4. Then, the Vegi Film is added to the mixture with stirring.

5. After the Vegi Film is added to the mixture, the resulting mixture is heated to about 80° C. to dissolve the Vegi Film.

6. After the Vegi Film dissolves, the mixture is cooled to ambient temperature.

7. Next, sufficient water is added to the mixture to compensate for water loss due to evaporation during heating.

The resulting edible adhesive is essentially fat and oil free, colorless, odorless and sprayable at ambient temperature. When analyzed according to Applicant's Cohesiveness and Viscosity Test Protocols, the adhesive is found to have a cohesiveness of 421 g/s and an adhesive viscosity of 620 cps.

### Application

Corn chips are heated in an oven set at 100° C. for about 30 minutes. The chips are removed from the oven, control chips are set aside and receive no further treatment. The edible particulate adhesive is sprayed on the remaining chips, and the seasoning is dusted on the chips. Next the edible particulate adhesive is again sprayed onto a sample of the seasoning coated corn chips. The chips that receive one coat of edible particulate adhesive and two coats of the edible particulate adhesive are as crisp as the control chips. The seasoning adheres slightly more securely to the chips that receive the second spray coat of edible particulate adhesive.

### Example 2

An edible particulate adhesive having the following formulation is prepared as follows:

| Ingredient | wt/wt % |
|---|---|
| N-Tack | 12.50 |
| Maltodextrin 150 | 38.00 |
| Caprol PGE 860 | 0.40 |
| Caprol 3GO | 0.40 |
| Vegi Film | 0.35 |
| Water | 48.35 |

1. The water is placed into a container.

2. The N-Tack and Maltodextrin 150 are slowly added to the water with constant stirring until the solution is aggregate free and essentially clear.

3. Next, the Caprol PGE 860 and Caprol 3GO are added to the N-Tack, Maltodextrin 150 and water mixture and the resulting mixture is mixed for 10 minutes.

4. Then, the Vegi Film is added to the mixture with stirring.

5. After the Vegi Film is added to the mixture, the resulting mixture is heated to about 80° C. to dissolve the Vegi Film.

6. After the Vegi Film dissolves, the mixture is cooled to ambient temperature.

7. Then, sufficient water is added to the mixture to compensate for water loss due to evaporation during heating.

The resulting edible adhesive is essentially fat and oil free, colorless, odorless and sprayable at ambient temperature. When analyzed according to Applicant's Cohesiveness and Viscosity Test Protocols, the adhesive is found to have a cohesiveness of 330 g/s and an adhesive viscosity of 160 cps.

### Application

The edible particulate is loaded into a hand held sprayer from Preval Spray Gun from Precision Valve Corporation Yonkers, N.Y. and the spray is applied at 23° C., to 275 g of low fat baked Tostitos™ corn chips from Frito-Lay™ . The edible particulate adhesive is not heated prior to or during application. Next, the chips are dusted with powdered Spicy Salsa Naturala from McCormick & Company, Baltimore, Md. USA. A second coat of edible particulate adhesive is then sprayed onto a portion of the corn chips. The corn chips are dried at about 40° C. for 1-2 hours. The resulting seasoning coated chips, with and without the second coat of edible particulate adhesive, are crisp, salsa flavored, and have a slight, visually pleasing sheen that is not tacky and which does not agglomerate.

### Example 3

An edible particulate adhesive having the following formulation is prepared as follows:

| Ingredient | wt/wt % |
|---|---|
| N-Tack | 20.00 |
| Maltodextrin 150 | 33.00 |
| Tween 80 | 1.90 |
| Vegi Film | 0.25 |
| Water | 44.85 |

1. The water is placed into a container.

2. The N-Tack and Maltodextrin 150 are slowly added to the water with constant stirring until the solution is aggregate free and essentially clear.

3. Next, the Tween 80 is added to the N-Tack, Maltodextrin 150 and water mixture and the resulting mixture is mixed for 10 minutes.

4. Then, the Vegi Film is added to the mixture with stirring.

5. After the Vegi Film is added to the mixture, the resulting mixture is heated to about 80° C. to dissolve the Vegi Film.

6. After the Vegi Film dissolved, the mixture is cooled to ambient temperature.

7. Next, sufficient water is added to the mixture to compensate for water loss due to evaporation during heating.

The resulting edible adhesive is essentially fat and oil free, colorless, odorless and sprayable at ambient temperature. When analyzed according to Applicant's Cohesiveness and Viscosity Test Protocols, the adhesive is found to have a cohesiveness of 330 g/s and an adhesive viscosity of 415 cps.

### Application

Corn chips are heated in an oven set at 160° C. for about 10 minutes. The chips are removed from the oven, control chips are set aside and receive no further treatment. The edible particulate adhesive is sprayed on the remaining chips, and the chips are dusted with seasoning. Next the edible particulate adhesive is again sprayed onto a sample of the seasoning coated corn chips. The chips that receive one coat of edible particulate adhesive and two coats of the edible particulate adhesive are as crisp as the control chips. The seasoning adheres slightly more securely to the chips that receive the second spray coat of edible particulate adhesive.

### Example 4

An edible particulate adhesive having the following formulation is prepared as follows:

| Ingredient | wt/wt % |
|---|---|
| N-Tack | 20.00 |
| Purity Gum 59 | 3.50 |
| Maltodextrin 150 | 20.00 |
| Tween 80 | 2.10 |
| Vegi Film | 0.25 |
| Water | 54.15 |

1. The water is placed into a container.

2. The N-Tack, Purity Gum 59 and Maltodextrin 150 are slowly added to the water with constant stirring until the solution is aggregate free and essentially clear.

3. Next, the Tween 80 is added to the N-Tack, Maltodextrin 150 and water mixture and the resulting mixture is mixed for 10 minutes.

4. Then, the Vegi Film is added to the mixture with stirring.

5. After the Vegi Film is added to the mixture, the resulting mixture is heated to about 80° C. to dissolve the Vegi Film.

6. After the Vegi Film dissolves, the mixture is cooled to ambient temperature.

7. Next, sufficient water is added to the mixture to compensate for water loss due to evaporation during heating.

The resulting edible adhesive is essentially fat and oil free, colorless, odorless and sprayable at ambient temperature. When analyzed according to Applicant's Cohesiveness and Viscosity Test Protocols, the adhesive is found to have a cohesiveness of 415 g/s and an adhesive viscosity of 285 cps.

### Application

Corn chips are heated in an oven at 100° C. for 30 minutes. The chips are removed from the oven. 10% by weight of Super Coat™ microencapsulated ferrous fumarate from Wright Nutrition, La., U.S.A. is combined with the edible particulate adhesive. The adhesive and particulate mixture is sprayed onto the hot corn chip as soon as they are removed from the oven at 1% by weight of chips. No further drying is necessary. The resulting mineral fortified chips are crisp and comparable in bite to untreated corn chips. When analyzed according to Applicant's Particle Adhesion Measurement Protocol, the percent particulate retention is found to be 95%.

### Example 5

An edible particulate adhesive having the following formulation is prepared as follows:

| Ingredient | wt/wt % |
|---|---|
| N-Tack | 15.00 |
| Purity Gum 59 | 6.50 |
| Maltodextrin 150 | 33.00 |
| Caprol PGE 860 | 0.40 |
| Caprol 3GO | 0.40 |
| Vegi Film | 0.35 |
| Water | 44.35 |

1. The water is placed into a container.

2. The N-Tack, Purity Gum and Maltodextrin 150 are slowly added to the water with constant stirring until the solution is aggregate free and essentially clear.

3. Next, the Caprol PGE 860 and Caprol 3GO are added to the N-Tack, Maltodextrin 150 and water mixture and the resulting mixture is mixed for 10 minutes.

4. Then, the Vegi Film is added to the mixture with stirring.

5. After the Vegi Film is added to the mixture, the resulting mixture is heated to about 80° C. to dissolve the Vegi Film.

6. After the Vegi Film dissolves, the mixture is cooled to ambient temperature.

7. Next, sufficient water is added to the mixture to compensate for water loss due to evaporation during heating.

The resulting edible adhesive is essentially fat and oil free, colorless, odorless and sprayable at ambient temperature. When analyzed according to Applicant's Cohesiveness and Viscosity Test Protocols, the adhesive is found to have a cohesiveness of 404 g/s and an adhesive viscosity of 435 cps.

What is claimed:

1. An edible adhesive comprising;
a.) from about 18% to about 71%, by weight, modified starch;
b.) from about 27% to about 80%, by weight, maltodextrin;
c.) from about 0.01% to about 7%, by weight, surfactant;
d.) from about 0.02% to about 2.5%, by weight, polysaccharide; and
e.) a solvent;
said edible adhesive having a cohesiveness from about 215 g/s to about 700 g/s and a viscosity of not more than about 800 cps.

2. The edible adhesive of claim 1 having a cohesiveness of from about 300 g/s to about 650 g/s.

3. The edible adhesive of claim 2 having a cohesiveness of from about 350 g/s to about 500 g/s.

4. The edible adhesive of claim 3 having a viscosity of not more than about 550 cps.

5. The edible adhesive of claim 1 having a viscosity of not more than about 650 cps.

6. The edible adhesive of claim 5 having a viscosity of not more than about 550 cps.

7. The edible adhesive of claim 1 comprising from about 18% to about 59%, by weight, modified starch.

8. The edible adhesive of claim 7 comprising from about 21% to about 50%, by weight, modified starch.

9. The edible adhesive of claim 1 comprising from about 27% to about 65%, by weight, maltodextrin.

10. The edible adhesive of claim 9 comprising from about 36% to about 58%, by weight, maltodextrin.

11. The edible adhesive of claim 1 comprising from about 0.2% to about 5.3%, by weight, surfactant.

12. The edible adhesive of claim 11 comprising from about 1% to about 4.5%, by weight, surfactant.

13. The edible adhesive of claim 1 comprising from about 0.1% to about 2.2%, by weight, polysaccharide.

14. The edible adhesive of claim 13 comprising from about 0.2% to about 1.6%, by weight, polysaccharide.

15. The edible adhesive of claim 1 comprising;
a.) from about 18% to about 59%, by weight, modified starch;
b.) from about 27% to about 65%, by weight, maltodextrin;
c.) from about 0.2% to about 5.3%, by weight, surfactant;
d.) from about 0.1% to about 2.2%, by weight, polysaccharide; and
e.) a solvent;
said edible adhesive having a cohesiveness from about 300 g/s to about 650 g/s and a viscosity of not more than about 650 cps.

16. The edible adhesive of claim 15 comprising;
a.) from about 21% to about 50%, by weight, modified starch;
b.) from about 36% to about 58%, by weight, maltodextrin;
c.) from about 1% to about 4.5%, by weight, surfactant;
d.) from about 0.2% to about 1.6%, by weight, polysaccharide; and
e.) a solvent;
said edible adhesive having a cohesiveness from about 350 g/s to about 500 g/s and a viscosity of not more than about 550 cps.

17. The edible adhesive of claim 1 wherein;
a.) said modified starch is a high amylopectin containing cold-water soluble modified starch;
b.) said maltodextrin has a dextrose equivalence of from about 4 to about 20;
c.) said surfactant is an ionic surfactant; and
d.) said polysaccharide is selected from the group consisting of carboxymethyl cellulose, methyl cellulose, ethyl cellulose, guar gum, locust bean gum, xanthan gum, carrageenans, gellan, konjac flour, sodium alginates, pectin, gum and mixtures thereof.

18. The edible adhesive of claim 17 comprising;
a.) from about 18% to about 59%, by weight, modified starch;
b.) from about 27% to about 65%, by weight, maltodextrin;
c.) from about 0.2% to about 5.3%, by weight, surfactant;
d.) from about 0.1% to about 2.2%, by weight, polysaccharide; and
e.) a solvent;
said edible adhesive having a cohesiveness from about 300 g/s to about 650 g/s and a viscosity of not more than about 650 cps.

19. The edible adhesive of claim 18 comprising;
a.) from about 21% to about 50%, by weight, modified starch;
b.) from about 36% to about 58%, by weight, maltodextrin;
c.) from about 1% to about 4.5%, by weight, surfactant;
d.) from about 0.2% to about 1.6%, by weight, polysaccharide; and
e.) a solvent;
said edible adhesive having a cohesiveness from about 350 g/s to about 500 g/s and a viscosity of not more than about 550 cps.

20. A food, having a coating comprising the edible adhesive of claim 1 and a particulate, said coating accounting for, when initially applied to said food, up to 5% of the weight of the coated food.

21. The coated food of claim 21, said coating accounting for up to 3% of the weight of the coated food.

22. The coated food of claim 22, said coating accounting for up to 1.5% of the weight of the coated food.

23. An adhesive component mix for preparing an edible adhesive comprising;
a.) from about 18% to about 71%, by weight, modified starch;
b.) from about 27% to about 80%, by weight, maltodextrin;
c.) from about 0.01% to about 7%, by weight, surfactant; and
d.) from about 0.02% to about 2.5%, by weight, polysaccharide.
